(19) United States
(12) Patent Application Publication
(10) Pub. No.: US 2020/0236944 A1
(43) Pub. Date: Jul. 30, 2020

(54) DIURON-CONTAINING FRUIT THINNING AGENT

(71) Applicant: ADAMA AGAN LTD., Ashdod (IL)

(72) Inventors: Frank SAALFELD, Leverkusen (DE); Heinrich SCHRAGE, Krefeld (DE)

(73) Assignee: ADAMA AGAN LTD., Ashdod (IL)

(21) Appl. No.: 16/754,319

(22) PCT Filed: Oct. 8, 2018
(86) PCT No.: PCT/EP2018/077294

§ 371 Date: Apr. 7, 2020

(30) Foreign Application Priority Data
Oct. 9, 2017 (EP) 17195515.6

(51) Int. Cl. A01N 47/30; A01N 59/06

(52) U.S. Cl. CPC A01N 47/30; A01N 59/06

(57) ABSTRACT

The present invention relates to a method for fruit thinning using 3-(3,4-dichlorophenyl)-1,1-dimethylurea (diuron) and calcium formate, as well as fruit thinning agents containing diuron and calcium formate.

The present invention relates to a method for fruit thinning using 3-(3,4-dichlorophenyl)-1,1-dimethylurea (diuron) and formates, in particular calcium formate, and fruit thinning agents containing diuron and formates, in particular calcium formate, which are particularly suitable for the aforementioned purpose.

Fruit thinning is widely considered to be one of the most important measures in fruit growing, with fruit thinning being the reduction of the fruit number. The fruit thinning is typically done either mechanically by machines or manually or by chemical means.

The control of the fruit size, the fruit color and/or the fruit quality are factors that have a significant impact on the economic efficiency.

Furthermore, an improvement of the flower buds in the following year or the breakage and prevention of alternation in endangered varieties and in young plants and the prevention of breakage of overloaded branches, as well as a strong exhaustion of the tree and a concomitant reduced frost hardness of the tree is observed.

In most growing regions, manual fruit thinning is prohibitive for cost reasons. The fruit thinning by machines can only be deployed to a limited extent, since it requires a certain form of growing of the trees, the fruit thinning can only be performed on the branches facing the rows and not in the depth of the tree, and the branches in the row direction. Furthermore, it typically causes a high level of collateral damage to the plant, such as leaf damage and concomitant possible infection by various pathogens.

The chemical fruit thinning is therefore advantageous.

However, known chemical fruit thinning substances such as urea and ammonium thiosulfate, which are not permitted for this purpose, for example, in Germany, show a highly unsatisfactory effectiveness and are often poorly tolerated by plants in the necessary high concentrations used. Other fruit thinning agents are also not particularly practicable in their action and plant tolerance, since depending on the stage of development of the fruit and the climatic conditions during and after the application always a very strong, variety-dependent lack of effect certainty was observed, such as in the case of 6-benzyladenine.

All of these known fruit thinning agents act on the hormone balance of the plant such as the plant hormones auxin and ethylene for apples. As a result, undesirable effects are often observed with the agents, such as a low effect at low concentrations, excessive fruit thinning in unfavorable conditions at the time of application or sometimes even the promotion of the growth of fruits. The agents belonging to the carbamate group used in many countries also act as insecticides and can only be deployed to a limited extent.

The use of photosynthesis inhibiting agents for fruit thinning has already been described in J. Amer. Soc. Hort. Sci. 115 (1): 14-19 (1990). However, the active ingredients mentioned therein have hitherto found no commercial use as fruit thinning agents, since the plant compatibility is unsatisfactory, as for example in the case of metribuzin.

From WO 03/020034 A it is known to use a fruit thinning agent containing the photosynthesis inhibiting active ingredient metamitron for apple trees. Metamitron is known for its plant damaging potential. In order to avoid leaf necroses, it is therefore necessary to apply it very precisely in terms of time and quantity. In addition, Metamitron is not suitable for fruit thinning of stone fruit crops.

H. Karnatz, “The toleance of the herbicide Diuron by Golden Delicious Apple Trees”, CAB Abstracts, 1970 is known to use Diuron in apple trees as a herbicide. The quantities used are significant and amount to several kilograms per hectare and application.

From G. I. Moss “Thinning ‘Washington’ Navel and ‘Late Valencia’ sweet orange fruits with photosynthetic inhibitors” is known to partially prevent the fruiting of orange trees with the administration of 2500 ppm diuron.

From Del Valle et al, “Thinning of peaches prunus-persica by temporary inhibition of photosynthesis with terbacil”, J. Am. Soc. Hort. Sc., Vol. 110, No. 6, 1985 is in addition to the fruit thinning with terbacil known to use diuron to reduce the rate of photosynthesis in peach leaves. However, Del Valle notes that leaf chlorosis occurs at a concentration of 1000 ppm diuron, and even when 100 ppm are used, the photosynthesis rate for peaches remains long-lasting and thus undesirably low.

WO 2013/174993 A describes fruit thinning agents containing diuron, which may optionally contain formates. Agents containing diuron but no formates are used, for example, in amounts of 150 to 600 ppm on apple trees with good success.

The problem with the use of agents containing photosynthesis inhibitors as fruit thinning agents is generally the application in an amount that causes no or only insignificant plant or leaf damage without risking the success of the fruit thinning.

Furthermore, it is desirable that the above-mentioned effects persist even in dosing or application errors, in particular overdoses applied by the end users and long lasting damage to the plantation is avoided in this case.

Furthermore, it is desirable to provide a fruit thinning agent, with which the fruit thinning can be carried out in order to avoid possible color changes to the ripe fruits as compared to manual thinning, and preferably to meet the above requirements also for pome fruit. It was therefore an object to provide improved fruit thinning agents, which are highly effective, and easy and safe to use.

It has now been found that certain fruit thinning agents containing diuron and calcium formate are particularly suitable.

The invention therefore comprises a method for fruit thinning, which is characterized in that an agent containing diuron is applied to plant organs. Furthermore, the invention includes the use of agents containing diuron for fruit thinning.

The agents according to the invention, hereinafter also referred to as ready-to-use fruit thinning agents, preferably contain
at least 95 wt.-% water
0.0005 wt.-% to 0.0095 preferably 0.015 wt.-% to 0.0080 wt.-%, particularly preferably 0.0025 to 0.0080 wt.% and even more preferably 0.0050 to 0.0080% wt.-% diuron
0.0001 wt.-% to 0.3 preferably 0.005 wt.-% to 0.02 wt.-%, particularly preferably 0.0010 to 0.03 wt.-% and even more preferably 0.0020 to 0.020% wt.-% calcium formate

and are also included in the scope of the invention as such.

It should be noted at this point that the scope of the invention includes any and all possible combinations of the components, value ranges, or method parameters described above and listed below, in general or mentioned in preferred areas.

The method according to the invention is particularly suitable for fruit thinning in stone fruit crops and pome fruit crops, wherein pome fruit crops are preferred.

Preferred pome fruit crops are those of the following varieties: all apple varieties such as Boskoop, Braeburn, Cox Orange, Elstar, Gala, Gloster, Golden Delicious, Fuji, Kanzi, Jamba, James Grieve, Jonagold, Jonathan, Lobo, McIntosh, Red Delicious, Spartan, all types of pear varieties such as Conference, quince and the Asian pear. Very particular preference is given to apple varieties, in particular the aforementioned.

Preferred stone fruit crops are those of sweet and sour cherries, peach, apricot and plum.

Fruit thinning takes place, for example, in the 3 to 30 mm fruit stage, preferably in the 6 to 30 mm fruit stage and particularly preferably in the 8 to 17 mm fruit stage, in particular for the pome fruit crops, the preferred crops applying in the same way.

In sweet and sour cherries, the fruit thinning takes place, for example, in the 3 to 17 mm fruit stage, or from the beginning of flowering to the end of flowering and at the time of bloom induction.

For the method according to the invention, agents, in particular ready-to-use fruit thinning agents, containing diuron are used, some of which are new and then also the subject of the invention.

The fruit thinning agents according to the invention further optionally contain additives.

Furthermore, the agents according to the invention also contain, or respectively do not contain, other fruit thinning active ingredients, growth regulators and other further agrochemical active ingredients.

The additives listed below each have, independently of each other, the possibility that they are not included.

As additives may be included, for example
Hygroscopic substances and/or humectants to regulate humidity: Hygroscopic substances are, for example, hygroscopic inorganic salts such as calcium chloride or calcium nitrate; magnesium chloride or magnesium nitrate. Suitable humectants are for example organic substances, such as glycerin, polydextrose, sorbitol, xylitol, propylene glycols, polyethylene glycols, or mixtures of these polyols.
Surface-active agents, such as surfactants. Surfactants may be for example nonionic, cationic and amphoteric surfactants, preferably anionic surfactants. Suitable anionic surfactants are, for example, alkyl sulfates, alkyl ether sulfates, alkyl aryl sulfonates, alkyl succinates, alkyl sulphosuccinates, N-alkoylsarkosinates, acyl taurates, acyl isethionates, alkyl phosphates, alkyl ether phosphates, alkyl ether carboxylates, alpha-olefin sulfonates, especially the alkali metal and alkaline earth metal salts, e.g. sodium, potassium, magnesium, calcium, as well as ammonium and triethanolamine salts. The alkyl ether sulfates, alkyl ether phosphates and alkyl ether carboxylates may each have, for example, between 1 to 10 ethylene oxide or propylene oxide units, preferably 1 to 3 ethylene oxide units. For example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecyl benzene sulfonate, triethanolamine dodecyl benzene sulfonate are suitable.
Wetting agents, for example alkali metal, alkaline earth metal, ammonium salts of aromatic sulfonic acids, for example lignin, phenol, naphthalene and dibutylnaphthalenesulfonic acid, and of fatty acids, alkyl and alkylaryl sulfonates, alkyl, lauryl ether and fatty alcohol sulfates, and salts of sulfated hexa-, hepta- and octadecanols or fatty alcohol glycol ethers, condensation products of sulfonated naphthalene and its derivatives with formaldehyde, condensation products of naphthalene or naphthalenesulfonic acids with phenol and formaldehyde, polyoxyethylenoctylphenolether, ethoxylated isooctyl, octyl or nonylphenol, alkylphenol or tributylphenylpolyglycolether, alkylarylpolyetheralkohole, isotridecylalkohol, fatty alcohol-ethylene oxide condensates, ethoxylated castor oil, polyoxyethylene alkyl ethers or polyoxypropylene, lauryl alcohol polyglycol ether acetate, sorbitol esters, lignin-sulphite liquors or methylcellulose.
Emulsifiers, such as sodium, potassium and ammonium salts of straight-chain aliphatic carboxylic acids of chain length C₁₂-C₂₀, sodiumhydroxyoctadecansulfonate, sodium, potassium and ammonium salts of hydroxy fatty acids of chain length C₁₂-C₂₀ and their sulfonation or acetylation products, alkyl sulfates, also known as triethanolamine salts, alkyl (C₁₀-C₂₀) sulfonates, alkyl (C₁₀-C₂₀) arylsulfonates, dimethyl dialkyl (C₈-C₁₈) ammonium chloride, acyl, alkyl, oleyl and alkylaryl oxethylates and their sulfonation products, alkali metal salts of sulfosuccinic acid esters with aliphatic saturated monohydric alcohols of chain length C₄-C₁₆, sulfosuccinic acid 4-esters with polyethylene glycol ethers of monohydric aliphatic alcohols of chain length C₁₀-C₁₂ (di-sodium salt), sulfosuccinic acid-4 Esters with polyethylene glycol nonyl phenyl ether (di-sodium salt), sulfosuccinic acid biscyclohexyl ester (sodium salt), lignin sulfonic acid and its calcium, magnesium, sodium and ammonium salts, polyoxyethylene sorbitan monooleate with ethylene oxide groups, resin acids, hydrogenated and dehydrogenated resin acids and their alkali metal salts, dodecylated diphenyl ether disulfonic acid sodium and copolymers of ethylene oxide and propylene oxide with a minimum content of 10% wt.-% ethylene oxide. Preferably used as emulsifiers: Sodium lauryl sulfate, sodium lauryl ether sulfate, ethoxylated (3 ethylene oxide groups); the polyethylene glycol (4-20)ethers of oleyl alcohol and the polyethene oxide (4-14)ethers of nonylphenol.
Dispersants, such as alkylphenol polyglycol ethers.
Stabilizers, such as cellulose and cellulose derivatives.
Adhesives, such as carboxymethylcellulose, natural and synthetic powdered, granular or latex-like polymers such as gum arabic, polyvinyl alcohol, polyvinyl acetate, and natural phospholipids such as cephalins and lecithins, and synthetic phospholipids, and paraffin oils.
Spreading agents, such as isopropyl myristate, polyoxyethylene nonylphenyl ether and polyoxyethylene lauryl phenyl ethers.
Organic solvents, such as mono- or polyhydric alcohols, esters, ketones and hydrocarbons. Examples of suitable solvents are paraffins, for example petroleum fractions, mineral and vegetable oils, butanol or glycol and their ethers and esters, ketones such as acetone, methyl ethyl ketone, methyl isobutyl ketone or cyclohexanone.
Fragrances and dyes, such as inorganic pigments, e.g. iron oxide, titanium oxide, ferrocyan blue and organic dyes, such as alizarin, azo and metal phthalocyanine dyes and trace nutrients such as salts of iron, manganese, boron, copper, cobalt, molybdenum and zinc.
Buffer substances, buffer systems or pH regulators.
Crystallization inhibitors such as N-alkylpyrrolidones, such as, for example, N-octylpyrrolidone and N-dodecylpyrrolidone, and also copolymers of polyvinylpyrrolidone and polyvinylalcohol, such as, for example, Luviskol VA 64® (Fa. BASF) known polyvinylpyrrolidone/polyvinyl alcohol copolymer, furthermore alkylcarboxylic dimethylamides, such as decanoic acid dimethylamide or known under the name Hallcomid® (Fa. Hall Comp.) C₆₋₁₂-alkanecarboxylic acid dimethylamide mixture, and also co-polymers of ethylene diamine with ethylene oxide and propylene oxide, for example the product known under the name Synperonic® T 304 (Fa. Uniqema).

Other fruit thinning active ingredients may be selected, for example, from the group consisting of:

metamitron, carbaryl, 2-(1-naphthylacetic) acid (NAA), benzyladenine, naphthyloxyacetic acid (NES), gibberillic acid, paclobutrazole, ammonium thiosulfate and urea, as well as ethylene ethers such as ethephon, especially in hardly thinnable or slightly alternating apple varieties such as Elstar or Red Delicious.

However, the agents used according to the invention preferably do not contain the aforementioned fruit thinning active ingredients.

As a growth regulator, for example, prohexadione-calcium can be used.

As further agrochemical active ingredients, the fruit thinning agents may contain, for example, fungicides and insecticides.

For example, fungicides may be selected from the group consisting of: sulfur (wettable sulfur), copper preparations, benzimidazole, bitertanol, dichlofluanid, fenamidone, fenarimol, fenhexamid, fludioxonil, fluopyram, fosetyl-aluminum, iprodione, myclobutanil, penconazole, triadimenol, vinclozolin, tolylfluanid (Euparen M®), captan, propineb, tebuconazole trifloxystrobin, kresoxim-methyl, dithianone, cyprodinil, pyrimethanil, mancozeb (Dithane Ultra®) and metiram.

For example, insecticides may be selected from the group consisting of: dimethoates, oxydemeton-methyl, malathion, parathion-methyl, phosphamidon, permethrin, amitraz, clofentezine, cyhalothrin, beta-cyfluthrin, fenproximate, diflubenzuron, methoxyfenozide, tebufenozide, imidacloprid, thiacloprid, thiametoxam, spirodiclofen, clofentezine, fenoxycarb, parathion-methyl, XenTari®, tebufenozide, diflubenzuron, pirimicarb, tebufenpyrad, fenpyroximate, rapeseed oil, mineral oil and lecithin, with imidacloprid and thiacloprid being particularly emphasized.

In one embodiment, however, the agents used according to the invention do not contain the aforementioned fungicides and/or insecticides.

The calcium formate can be introduced into the agents to be used according to the invention preferably in the form of calcium formate. The term calcium formate is to be understood according to the invention as meaning that calcium ions and formate ions must be present simultaneously in the agent to be used according to the invention. For the question of quantity, the limiting component formate or calcium with respect to the formula of calcium formate Ca(HCOO)₂ is to be used.

Therefore, besides the preferred use of calcium formate as such, the incorporation or presence of calcium formate via various salt combinations containing calcium and formate is possible. For example, these are combinations of
1) salts which are selected from the group of alkali metal formates such as, for example, potassium formate and sodium formate, alkali metal diformates such as, for example, potassium diformate and sodium diformate or mixtures of such formates with
2) salts selected from the group of calcium salts of organic carboxylic acids other than calcium formate, calcium chloride, calcium nitrate.

Calcium formate is particularly preferred because it avoids problems that may optionally occur with the other calcium salts commonly used in agrochemical formulations. For example, calcium formate is not hygroscopic or contaminated by alkaline impurities (Ca(OH)₂), such as commercial CaCl₂, and is not as water-soluble as calcium carbonate. Calcium formate-containing formulations are also more rain resistant than the commonly used calcium salts (nitrate, carbonate and chloride).

As a side effect of calcium salts it is observed that the agents of the invention when applied to young plant organs (leaves and fruits), are well suited to prevent calcium deficiency symptoms in the plants and especially in the fruits such as bitter pit in apples.

Surprisingly, it has also been found within the scope of the invention that calcium formate is able to markedly reduce the susceptibility of the plant organs with respect to phytotoxicity, in particular in the case of misdosing.

Furthermore, calcium formate makes it possible to easily formulate agents according to the invention and which can be used according to the invention.

The ready-to-use fruit thinning agents are preferably obtained from concentrates of agents, for example by mixing water, in order to simplify production, storage and transport.

Concentrates of agents may be formulated in any form. Suitable formulations are, for example, capsule suspensions (CS), water-soluble concentrates (SL), suspension concentrates (SC), wettable powders (WP), water-dispersible granules (WG), wherein water-soluble concentrates (SL), suspension concentrates (SC) and water-dispersible granules (WG) are generally preferred. In principle, preferred types of formulations are essentially dependent on the constituents used and their physical properties. However, since these are known, it is common practice for a person skilled in the art to determine a preferred formulation type in a few experiments.

Concentrates of agents may contain, for example
more than 0.2 wt.-% to 30 wt.-% preferably 0.5 wt.-% to 30 wt.-%, particularly preferably 2 to 20 wt.-%, and even more preferably 12 to 18% wt.-% diuron.
30 wt.-% to 70 wt.-% preferably 2 wt.-% to 70 wt.-%, particularly preferably 2 wt.-% to 25 wt.-% and even more preferably 7 to 15 wt.-% of calcium formate
water

Wherein the sum of water, diuron and calcium formate is 90 to 100 wt.-%, preferably 95 to 100 wt.-% and particularly preferably 97 to 100 wt.-%.

The difference to 100 wt.-%, where present, may, for example, be formed by the above-mentioned additives and/or further fruit thinning active ingredients and/or insecticides and/or herbicides, the difference preferably comprises to 100 wt.-%, where present, the additives but not other fruit thinning active ingredients, insecticides and herbicides.

The weight ratio of diuron and calcium formate in the fruit thinning agents and concentrates of agents of the present invention is, for example, 1.0:0.4 to 1.0:3.0, preferably 1.0:0.5 to 1.0:1.5, and even more preferably 1,0:0.5 to 1.0:1.0.

With regard to the other constituents of the concentrates of the agents in addition to diuron, such as additives, other fruit thinning agents, growth regulators and other further agrochemical active ingredients, the statements made above with regard to the ready-to-use fruit thinning agents apply analogously.

The application of ready-to-use agents is carried out by conventional methods, for example by splashing, pouring, spraying, injecting or brushing. The application is preferably carried out directly on the plant organs, in particular on leaves and/or fruits.

For the method according to the invention, for example, so much of ready-to-use agents is applied that 0.025 to 0.2 kg/ha, preferably 0.040 to 0.15 kg/ha, particularly preferably 0.050 to 0.080 kg/ha of diuron, are preferably applied per application.

The number of applications may be, for example, one to six, preferably one, two or three, even more preferably one or two.

The invention has the particular advantage that an efficient fruit thinning agent is provided, which allows a good thinning performance at low dosage without appreciable other plant damage and thereby allows the fruits to acquire a color value, which can otherwise usually only be achieved with manual thinning.

### EXAMPLES

In a trial field planted with Braeburn Marin Red M9 apple trees (planting distances 3.5×1.0 m) from a planting in the spring of 2006, at treatment date 1 at 10 mm fruit size of the royal flower and at treatment date 2 at 10 mm size of the last flowers respectively four plots of 5 trees each were sprayed with defined amounts of the agents defined below. Of the five trees, 3 marked branches of 3 trees of uniform flowering strength were evaluated according to the criteria given in Table 1 below and the 3 trees in to according to the criteria given in Table 2. The treatment was carried out at an application rate of 500 1/water per hectare and meter crown height which corresponded to 1000 1 per hectare.
Control experiment 1:without fruit thinning
Manual experiment 6: fruit thinning was done manually only
Experiments 2 and 3: fruit thinning is carried out using the amounts of ready-to-use agents given above, which are obtained by mixing the amounts of a suspension concentrate containing 808 g/l diuron, 50 g/l ethanediol, 34 g/l surfactants and other formulation auxiliaries and 380 g/l water.
Experiments 4 and 5: fruit thinning is carried out with the above-indicated amounts of ready-to-use agents which are obtained by mixing the amounts of a suspension concentrate comprising 152 g/l diuron, 96 g/l calcium formate, 5 g/l surfactants and other formulation auxiliaries and 857 g/l of water.
Experiment 2: 1.875 ml of the suspension concentrate were dissolved in 10 1 of water (about 150 ppm) and applied during treatment day 1 and 2, as described above.
Experiment 3: 1.875 ml of the suspension concentrate were dissolved in 10 1 of water (about 150 ppm) and applied during treatment day 1, as described above.
Experiment 4: 5.0 ml of the suspension concentrate with calcium formate were dissolved in 10 1 of water (about 75 ppm) and applied during treatment day 1, as described above.
Experiment 5: 3.75 ml of the suspension concentrate with calcium formate were dissolved in 101 of water (about 56.25 ppm) and applied during treatment day 1 and 2, as described above.

TABLE 1
Evaluation of each three marked branches on three trees per plot

| | | | | | | | Number of fruits | Number of fruits |
|---|---|---|---|---|---|---|---|---|
| | Number | | | | Fruit | | before June fruit | after June fruit |
| Experiment No. | Fruits/tree | Kg/tree | Size mm | % Colour | weight (g) | Tox* | drop | drop |
| 1 (without) | 148 | 20.549 | 68.64 | 62.25 | 139.3 | 1.00 | 20.89 | 11.28 |
| 2 (re exp.) | 96 | 15.923 | 73.11 | 54.16 | 167.6 | 3.88 | 20.67 | 7.39 |
| 3 (re exp.) | 50 | 9.114 | 75.89 | 59.33 | 191.4 | 4.68 | 19.67 | 3.89 |
| 4 | 82 | 12.884 | 74.09 | 64.92 | 172.6 | 3.38 | 19.78 | 5.19 |
| 5 | 86 | 15.811 | 73.32 | 63.36 | 168.5 | 3.33 | 17.81 | 6.33 |
| 6 (man.) | 117 | 16.985 | 70.65 | 63.92 | 147.3 | 1.00 | 26.50 | 12.34 |

*Tox = phytotoxicity, relative scale

1-7. (canceled)

8. A composition comprising:
(a) at least 95% by weight of water,
(b) 0.0005% to 0.0095% by weight of diuron, and
(c) 0.0001% to 0.3% by weight of calcium formate.

9. The composition of claim 8, wherein the composition comprises 0.015% to 0.0080% by weight of diuron.

10. The composition of claim 8, wherein the composition comprises 0.005% to 0.02% by weight of calcium formate.

11. The composition of claim 8, wherein the weight ratio of diuron and calcium formate is 1.0:0.4 to 1.0:3.0.

12. The composition of claim 8, wherein the weight ratio of diuron and calcium formate is 1.0:0.5 to 1.0:1.5.

13. The composition of claim 8, wherein the weight ratio of diuron and calcium formate is 1.0:0.5 to 1.0:1.0.

14. A method for of thinning fruit on a plant comprising applying the composition of claim 8 to at least one plant organ so as to thereby thin fruits on the plant.

15. The method of claim 14, wherein:
(a) the composition is applied in the 3 to 30 mm fruit stage,
(b) the composition is applied at an amount of 0.025 to 0.2 kg/ha of diuron per application, and/or
(c) the composition is applied one to six times.

16. The method of claim 14, wherein:
(a) the composition is applied in the 8 to 17 mm fruit stage,
(b) the composition is applied at an amount of 0.050 to 0.080 kg/ha of diuron per application, and/or
(c) the composition is applied one or two times.

17. A composition concentrate comprising:
(a) 0.2% to 30% by weight of diuron,
(b) 30% to 70% by weight of calcium formate, and
(c) water,
wherein the sum of water, diuron and calcium formate is 90% to 100% by weight.

18. The composition concentrate of claim 17, wherein the composition concentrate comprises 12% to 18% by weight of diuron.

19. The composition concentrate of claim 17, wherein the composition concentrate comprises 7% to 15% of calcium formate.

20. The composition concentrate of claim 17, wherein the sum of water, diuron and calcium formate is 95% to 100% by weight.

21. The composition concentrate of claim 17, wherein sum of water, diuron and calcium formate is 97% to 100% by weight.

22. The composition concentrate of claim 17, wherein the weight ratio of diuron and calcium formate is 1.0:0.4 to 1.0:3.0.

23. The composition concentrate of claim 17, wherein the weight ratio of diuron and calcium formate is 1.0:0.5 to 1.0:1.5.

24. The composition concentrate of claim 17, wherein the weight ratio of diuron and calcium formate is 1.0:0.5 to 1.0:1.0.

25. A method for of thinning fruit on a plant comprising applying the composition concentrate of claim 17 to at least one plant organ so as to thereby thin fruits on the plant.

26. The method of claim 25, wherein the composition concentrate is mixed with water prior to application.

27. The method of claim 25, wherein:
(a) the composition concentrate is applied in the 3 to 30 mm fruit stage,
(b) the composition concentrate is applied at an amount of 0.025 to 0.2 kg/ha of diuron per application, and/or
(c) the composition concentrate is applied one to six times.
